(19) United States
(12) Patent Application Publication
(10) Pub. No.: US 2015/0134776 A1
(43) Pub. Date: May 14, 2015

(54) INJECTED ANALYTICS SERVICE FOR WEB DISTRIBUTED INTERFACES

(71) Applicant: Empire Technology Development LLC, Wilmington, DE (US)

(72) Inventor: Ezekiel Kruglick, Poway, CA (US)

(21) Appl. No.: 14/351,508

(22) PCT Filed: Jul. 19, 2013
(86) PCT No.: PCT/US13/51339

§ 371 Date: Apr. 11, 2014

(51) Int. Cl. H04L 29/08

(52) U.S. Cl. CPC H04L 67/10; H04L 67/025
USPC 709/217

(57) ABSTRACT

Technologies are generally described for integrating an injected analytics service into a user interface (UI) content distribution system to generate per-user and per-control level analytics for web distributed interfaces. In some examples, an analytics engine of the UI content distribution system may generate differentiated analytics payload elements for each control destination at the point of UI content distribution. The analytics engine may then inject the analytics payload elements into UI content payloads delivered to each destination. The differentiated analytics payload elements may create distinct analytics output for data processing and analysis at a distributed user interface (DUI) analytics database, even when multiple devices or users are part of a same application session or login.

### BACKGROUND

Unless otherwise indicated herein, the materials described in this section are not prior art to the claims in this application and are not admitted to be prior art by inclusion in this section.

Conventional techniques for distributing user interfaces and the proliferation of second and third screens for users may suggest additional uses for such distribution. Furthermore, cloud deployment of applications may create more distance between user hardware and an actual application hosted at a datacenter. The distance may provide an environment in which companies or subscribers may arrange to deliver control elements to a variety of different end destinations. In conventional paradigms, however, little may be known about which end user may activate each application function or control element, making development, market optimization, or troubleshooting of such user interface distribution systems potentially erratic and difficult.

A control element redistribution system that works at the local network, enterprise network, or service provider end on web delivered content, moving or copying control elements from one web session to another may provide no indication at the application source that any of the control element transfers are going on. Thus, the application operator may have no indications that different individuals may be interacting with the application or what their different characteristics might be and how those may characterize particular user groups. This lack of data is against current application programming trends and user analytics which emphasize data and active testing of alternates across slices of user populations.

### SUMMARY

The present disclosure generally describes methods for providing injected analytics service for web distributed interfaces.

According to some examples, a method is described for providing an analytics service for web distributed interface. The method may include receiving user interface content to be distributed to one or more control points and generating differentiated analytics payload elements for each control point at a point of user interface content distribution. The method may also include injecting the analytics payload elements into user interface content payloads delivered to each control point.

According to other examples, a user interface content distribution system operable to provide an analytics service for web distributed interfaces is described. The system may include a first server configured to receive user interface content to be distributed to one or more control points. The system may also include an analytics engine configured to generate differentiated analytics payload elements for each control destination and inject the analytics payload elements into user interface content payloads delivered to each control point. The system may further include a second server configured to distribute the user interface content with the analytics payload elements to the control points.

According to further examples, a user interface content distribution system operable to integrate an analytics service for web distributed interfaces is described. The system may include a content module configured to receive user interface content to be distributed to one or more control points. The system may also include analytics engine configured to generate differentiated analytics payload elements for each control destination and inject the analytics payload elements into user interface content payloads delivered to each control point. The system may further include an element distributor configured to distribute the user interface content with the analytics payload elements to the control points.

According to yet further examples, a computer readable storage medium is described. The computer readable storage medium may include instructions stored thereon, which when executed may cause a method for providing an analytics service for web distributed interfaces to be executed by one or more computing devices, where the method includes actions of claims 1-14.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments accordance with the disclosure and are, therefore, not to be considered limiting of its scope, the disclosure will be described with additional specificity and detail through use of the accompanying drawings, in which:

FIG. 1 illustrates an example networked environment, where user interface content distribution with injected analytics may be implemented;

FIG. 2 illustrates an example user interface content distribution system and associated modules and tasks, conceptually;

FIG. 3 illustrates three example layers for implementing different aspects of a user interface content distribution with injected analytics in a user-side application environment;

FIG. 4 illustrates a general purpose computing device, which may be used to implement user interface content distribution with injected analytics;

FIG. 5 is a flow diagram illustrating an example method that may be performed by a computing device such as the computing device in FIG. 4; and

FIG. 6 illustrates a block diagram of an example computer program product, all arranged in accordance with at least some embodiments as described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, among other things, to compositions, methods, apparatus, systems, devices, and/or computer program products related to providing injected analytics service for web distributed interfaces.

Briefly stated, technologies are generally provided for integrating an injected analytics service into a user interface (III) content distribution system to generate per-user and per-control level analytics for web distributed interfaces. In some examples, an analytics engine of the UI content distribution system may generate differentiated analytics payload dements for each control destination at the point of UI content distribution. The analytics engine may then inject the analytics payload elements into UI content payloads delivered to each destination. The differentiated analytics payload elements may create distinct analytics output for data processing and analysis at a distributed user interface (DUI) analytics database, even when multiple devices or users are part of a same application session or login.

A “web distributed interface” as used herein refers to an interface that is distributed through multiple control points. The distribution of interfaces may be implemented in any networked system such as enterprise networks, local area networks, wide area networks, and the Internet (commonly referred to as the “world wide web”). Thus, embodiments are not limited to interfaces distributed over the Internet, but may be implemented in other types of networks as well.

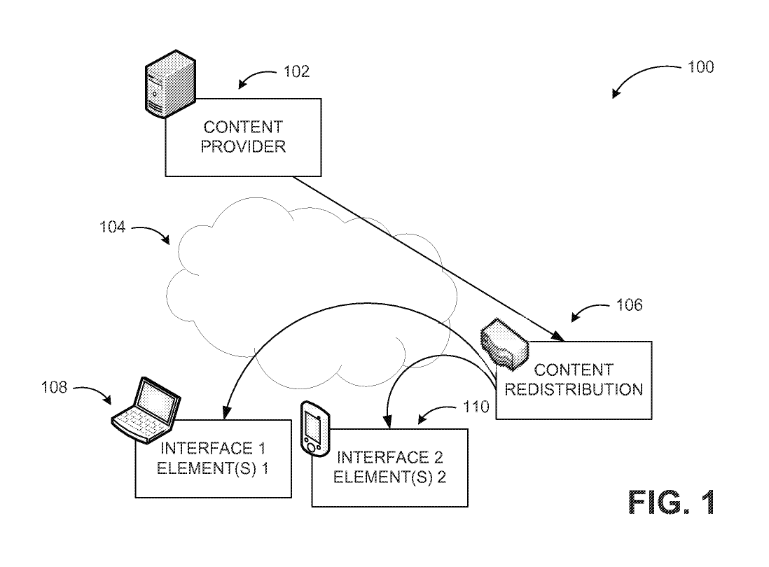

FIG. 1 illustrates an example networked environment, where user interface content distribution with injected analytics may be implemented, arranged in accordance with at least some embodiments as described herein.

As shown in a diagram 100, an example networked environment may include a content provider 102, a user interface (UI) content distribution system 106, a laptop 108, and a PDA 110, communicating via a cloud 104.

The content provider 102 may deliver UI content to the UI content distribution system 106. The received UI content may be severed into one or more elements, injected with differentiated analytics, and distributed to one or more control points, the laptop 108 and the PDA 110. The UI content distribution system 106 may be part of an Internet Service Provider (ISP), a routing device provider, a Software as a Service (SaaS) entity, and/or an independent analytics service. Each control point may include one of a user, a session, and/or a device. The UI content may include one or more UI content elements that may be distributed to one or more web distributed interfaces at each control point. For example, one UI content element may be distributed to one web distributed interface of the laptop 108 and two UI content elements may be distributed to two web distributed interfaces of the PDA 110. The distributed UI content elements may include duplicate elements among the control points.

A UI content distribution system that works at a local area network (LAN), enterprise network, or ISP end on web delivered content may move or copy content from one web session to another. There may be no indication at the application source that the action is occurring. As a result, the application operator may have no indications that different control points might be interacting with the application or what their different characteristics might be and how those may characterize particular control point groups. The lack of individualized data in current application programming trends and user analytics may create confusing, muffled data. A means for individually tracking different control points and their behaviors in a distributed interface environment may be necessary to achieve desired clear, meaningful data. Such a system may be able to discriminate different control points and the system overall may be able to track all control points, not just those who have certain controls that may have originally been associated with analytics code.

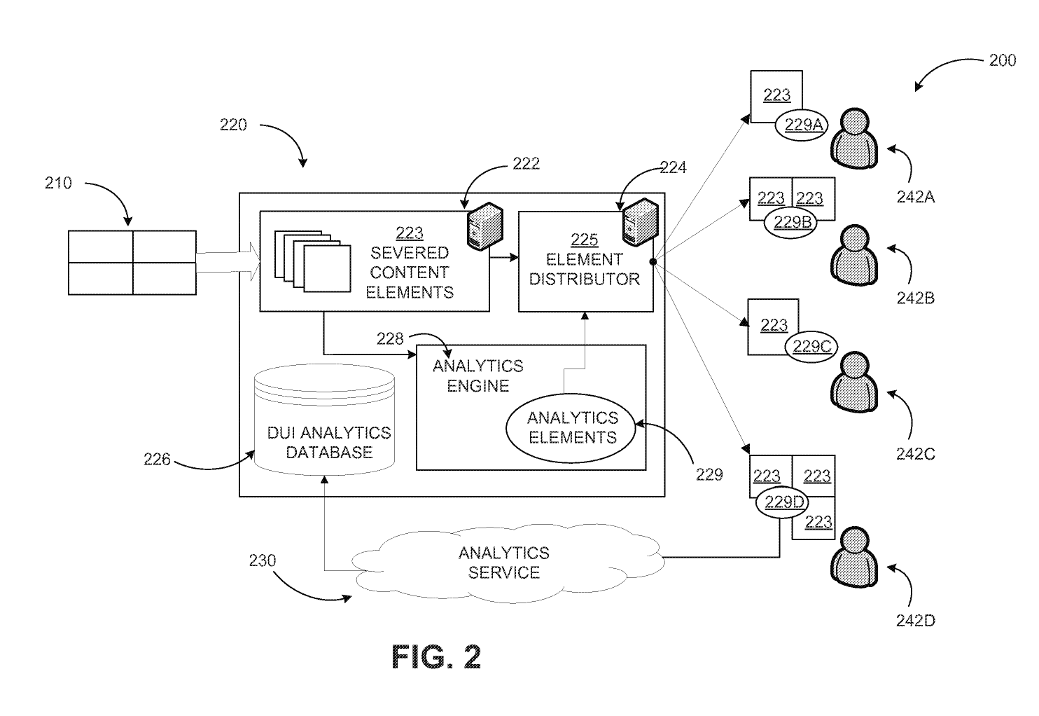

FIG. 2 illustrates an example user interface content distribution system and associated modules and tasks, conceptually, arranged in accordance with at least some embodiments as described herein.

As shown in a diagram 200, a user interface (UI) content distribution system 220, including a first server 222, a second server 224, an analytics engine 228, and a distributed user interface (DUI) analytics database 226, may receive a UI multi-element content 210 to be distributed to one more users 242 A-D.

The UI multi-element content 210 may be received by the first server 222 of the UI content distribution system 220. At the first server 222, which may include a content module, the UI multi-element content 210 may be rendered into one or more severed UI content elements 223 and provided to the second server 224 to be distributed to one or more control points. Prior to distribution, the analytics engine 228 may generate analytics payload elements 229 differentiated for each control point, and inject the analytics payload elements 229 into corresponding UI content elements to be distributed to each control point. The analytics payload elements may be differentiated by inserting a different token into each analytics payload element such that analytics profiles for control points associated with the analytics payload elements may be maintained separate. Tokens may be dynamically generated and linked to a session. For example analytics function may call an HTTPS address with a URL that includes a token by including a string that looks like ?Token=A346KJ92348 and the analytics engine may place copies of the analytic codes with different tokens in each of the outgoing elements upon receiving the token.

Once the payload elements are injected into the UI elements, the second server 224 may distribute the one or more UI content elements 223 through an element distributor module 225 to users 240 A-D. For example, one UI content element 223 may be distributed to users 240 A and C, two UI content elements 223 may be distributed to user 240 B, and three UI content elements may be distributed to user 240 D. The users 240A-D may represent multiple devices with fewer logins or actual people behind them. Each differentiated analytics payload element 229 A-D may connect back to an analytics service 230 and the data may be delivered to the DUI analytics database 226, managed by one of the first and second servers of the UI content distribution system 220. The analytics service 230 may be executed on a third server separate from the UI content distribution system 220.

Alternatively, the analytics engine 228 may optionally receive the one or more severed content elements 223 from the first server 222 to allow the system to take existing differentiated analytics payload elements, for example, 229 D, and replace them with individualized analytics payload elements 229. Replacing the existing analytics payload elements with individualized analytics payload elements may include adding a dynamic uniform resource locator (URL) string to indicate a user identity and control elements among the distributed user interface content. The UI content elements including the individualized analytics payload elements may then use the same service and account number so that the original application may get direct feedback as well.

Many analytics services 230 may not be prepared for such complex scenarios where each control point may be receiving different elements of the same content. To compensate, there may be a connection between the element distributor module 225 and the DUI analytics database 226 to record which UI content elements 223 may be distributed to which control points and in what fashion to ensure complete data is gathered. If the delivered analytics payload elements 229 A-D include account identification such that the analytics service 230 may deliver the resulting information directly to an original content provider, the element distributor module 225 may further be designed to deliver information associated with each analytics payload element 229 A-D to the content provider. The content provider may then conduct informed analysis such as statistical analysis on usage, users, etc.

If the analytics engine 228 uses existing analytics information from the original UI content elements 223, the analytics engine may transform or otherwise modify such analytics to generate the analytics payload elements 229 A-D to indicate user identity and control elements among the distributed UI population. The existing analytics information may be easily injected back into the UI content elements 223. As a result, a web page with many controls and one analytics payload element may be severed into dozens of controls to be distributed to multiple control points, each with an analytics payload element similar to the single one in the original content, but with new tokens and/or identifying information associated with it.

If the users 240 A-D have across platform logins or otherwise have to login to use the UI content distribution system 220, the analytics engine 228 may take user identity into account when generating analytics. For example, an end user 240 D who is logged in via a web application may receive a specific and unique application-interfacing cookie that may be different from other users 240 A-C. Such tracking elements and analytics payload elements may also be gated by personal information, for example limiting the tracking implemented on users under a certain age, who also may be restricted from receiving certain UI content elements. Another useful property of the presented system may be the ability to track which UI content elements users displace to their mobile screens or which UI content elements they send away to not be used.

UI distribution systems may mirror or duplicate analytics payload elements, creating single analytics entries composed of nonsensical data across multiple users and devices. Alternately, the analytics payload elements may be injected in just one of many possible distributed UI elements, providing a very limited view. Instead, a system according to embodiments may allow a UI content element to be injected with many differentiated analytics payload elements as the system distributes the UI content elements to many different control points, where differentiated identified analytics payload elements may include different tokens for each user and/or control. Injection may also process existing analytics so that the original content provider receives many analytics records representing the many control points, distributed out appropriately to tell the control points apart. As a result, the presented system may provide a meaningful analysis of who is using each UI content element and how (for example, on what kind of device) allowing targeted development or customer offers.

The challenge of providing control point specific analytics for distributed interfaces imposed on web content may have several facets. One challenge may be that the source of the content does not necessarily know how content is to be severed or how many control points may ultimately receive the content, meaning the source may not be able to provide analytics tokens appropriately. The challenge may occur whether the source is a content serving system and the distributed UI is handled by the same organization as the content or (and especially) if the distribution of the UI is handled by a different entity, such as user or enterprise software on a LAN. One advantage may be that the distribution system, whomever owns it, may be handling web content suitable for injection of additional analytics payload elements. There may be a vector by Which the additional analytics payload elements may be injected individually for each piece of distributed user interface, but the injection may have to be done at the distribution of interface point, not content generation.

There may be a variety of potential models for implementing a system according to embodiments described herein. In one example model, the UI content distribution system 220 may use the individualized analytics data generated from the injected analytics service to both enhance its own service (UI content distribution) and to provide additional analysis back to an original content provider. The enhancements and additional analysis may be offered as extra services by network ISPs or even home router vendors to allow users to transport content. In another example model, the injected analytics service may represent part of the UI content distribution system 220 that may be a service in a larger cloud deployment, such as a Software as a Service (SaaS) product that includes UI content distribution as a feature. The injected analytics service may be a part of the SaaS product deployment or may be a purchased subservice, for example, made available via application programming interfaces (APIs) by a datacenter owner. In yet another example model, the injected analytics service may be offered by the analytics services 230, which may be associated with content delivery networks that may allow the services to have a handover point at Which to inject delivered content. Even a combination of these three models may be implemented.

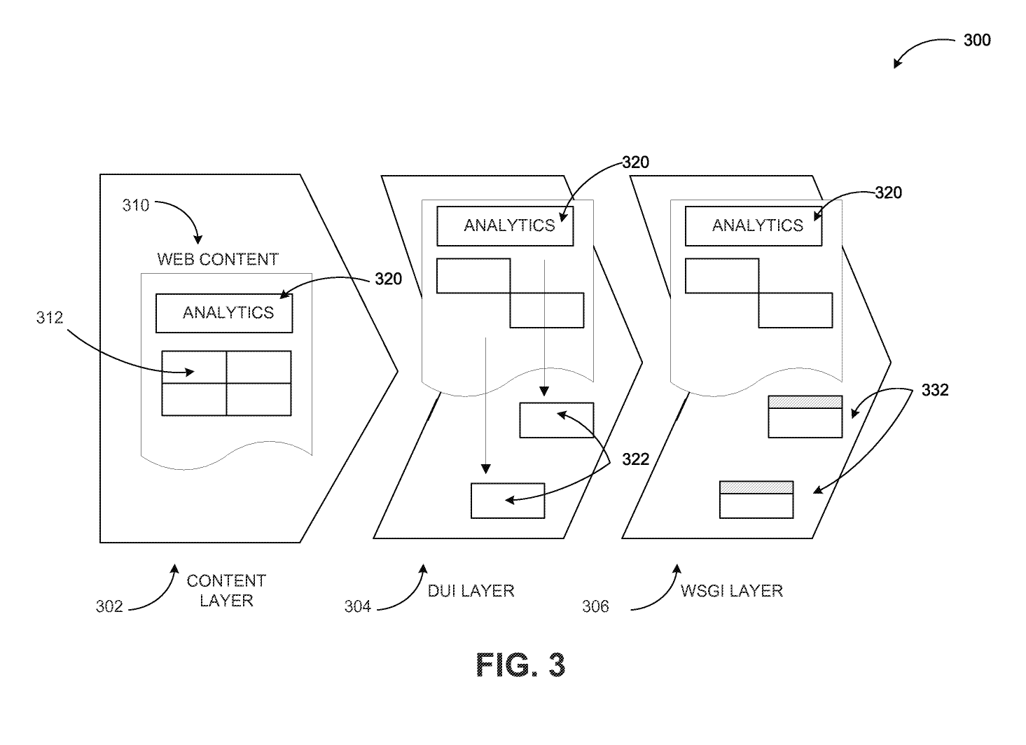

FIG. 3 illustrates three example layers for implementing different aspects of a user interface (UI) content distribution with injected analytics in a user-side application environment, arranged in accordance with at least some embodiments as described herein.

As shown in a diagram 300, a content layer 302, a distributed user interface (DUI) layer 304, and a web server gateway interface (WSGI) layer 306 may implement different aspects of a user interface content distribution with injected analytics in a user-side application environment. The content layer 302 may include web content 310 having distributable UI multi-content elements 312 and embedded analytics 320. The DUI layer 304 may include the embedded analytics 320 and severed UI content elements 322 of the web content. The WSGI layer 306 may include the embedded analytics 320 and severed UI content elements with injected analytics payload elements 332, the analytics payload elements injected by an analytics engine implemented in the WSGI layer.

UI content, such as UI multi-content elements 312 of the web content 310, may be generated at the content layer 302. Upon a control point request, the DUI layer 304 may render the severed UI content elements 322 from the UI multi-content elements 312 of the content layer 302 to be distributed to one or more control points. The analytics engine, implemented in the WSGI layer 306, may then generate analytics payload elements for the UI content elements 322, the analytics payload elements differentiated for each UI content element based on the one or more control points to which they may be distributed. The UI content elements 322 may then be injected with the analytics payload elements 332.

While each layer may include the embedded analytics 320 within the web content 310, these analytics may not be injected into the UI content elements. Control element distribution may occur separately from the content generation or distribution so existing systems for including analytics in web content may generate confusing results. For example, the embedded analytics 320 in the web content 310 may not be captured and distributed when certain control elements are distributed causing no data to be generated from any control points with those control elements. Conversely, the embedded analytics 320 in the web content 310 may get captured with a particular control element that is distributed to many control points. The returned data for a single analytics token generated among the content may represent conflicting locations and the muddled cookies or device fingerprinting from a variety of control points may not likely match any database or tracking service. As a result, no demographic or associative data may be collected.

Many content management systems may be designed to pull content together from multiple services within the deployment, including dynamic content, to form a final set of content which is then served to a control point. To allow a plug-and-play interface during the chain of content handling a WSGI standard may be used. WSGI compliant applications may be stacked. Those in the middle of the stack may be called middleware and may implement both sides of the WSGI interface, application, and server. Any middleware may be inserted into a WSGI compliant snick by inserting the middleware into the flow of the content. The WSGI application interface may be implemented as a callable object: a function, a method, a class or an instance with a_call_method. The WSGI compliant middleware may accept two inputs a dictionary structure (hash table dictionary) and a callback function that sends HTTP status and/or code messages to the server and returns the response body to the server as output.

Adding analytics to web content may be accomplished by adding an element provided by the analytics provider. In a first scenario, the web content 310 may have distributable UI multi-content elements 312 and the embedded analytics 320. A WSGI middleware may be implemented after the distribution middleware, the DUI layer 304 that implements analytics on any transiting UI content that is distributed. Replacing the DUI element detection with deployment specific DUI tags may provide a WSGI compliant plug-in module capable of injecting analytics. However, the same analytics payload elements may be injected in everything. To inject different analytics payloads elements into different DUI elements may involve various added tags and logical selections in the above that may substantially increase the overall size.

In a second scenario, the UI distribution system may operate in a location separate from the content generation. Similar to DUI management, a reverse proxy or content distribution network (CDN) may operate under principles of preserving or caching portions of content and redelivering them in response to similar queries. As a result, analytics payload elements may be implemented in a WSGI stack of the reverse proxy or CDN. The content layer 302 may be a reverse proxy or cache and the UI content distribution system may be located in a separate computing facility.

In a third scenario, UI content distribution may occur at a user end of connection without informing content servers. If the user is applying a user-side distributed user interface (DUI) application, normally no indications may be sent to the content servers. Effectively, such systems may generate their own DUI applications from containers holding other applications or views.

For example, pieces of applications may be served to a remote web browser session, The session may be generated by the user-side DUI application, using images of parts of the ongoing application being distributed. In order to propagate analytics, the user-side DUI application may sense the analytics payload elements in the application being distributed and inject copies of those analytics into the web sessions served to the DUI destinations in the web content. The injected copies may include any appropriate modifications, such as changing property IDs in accordance with meta-information if the application has DUI “terms” associated with it.

As one specific example, a user-side DUI application may take images of an ongoing application and bundle those into, effectively, a video stream that the application serves as web content to remote browsers. A WSGI layer may be introduced above the video stream and packaging layer. The same code may work because the user-side DUI application may be using web sessions, locally generated by the user-side DUI application, to deliver content.

If a DUI generating application does not use web standards, instead using custom executables at both ends to generate and display the distributed elements using custom content delivery formats, the applications may need to implement analytics internally. The analytics may then be conveyed back to the original session and simulated to the single web session that the DUI generating application is distributing.

The examples in FIGS. 1 through 3 have been described using specific systems and processes in which injected analytics service for web distributed interfaces may be provided. Embodiments for providing injected analytics service for web distributed interfaces are not limited to the systems and processes according to these examples.

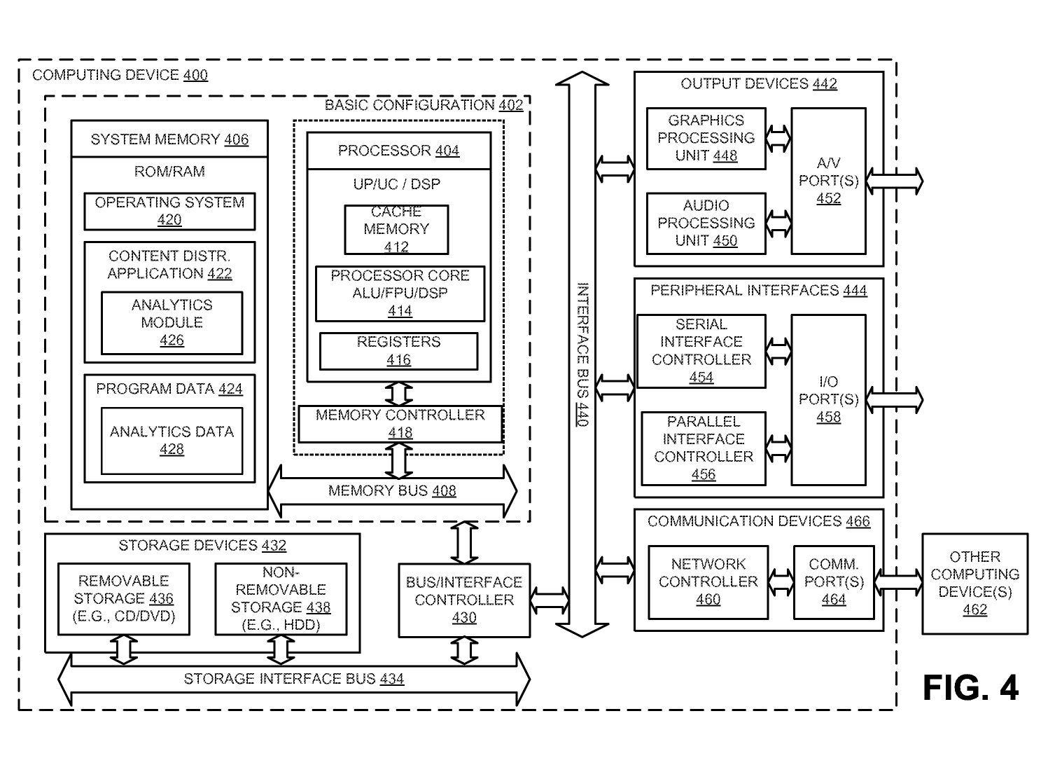

FIG. 4 illustrates a general purpose computing device 400, which may be used to implement user interface content distribution with injected analytics, arranged in accordance with at least some embodiments as described herein.

For example, the computing device 400 may be used to provide injected analytics service for web distributed interfaces as described herein. In an example basic configuration 402, the computing device 400 may include one or more processors 404 and a system memory 406. A memory bus 408 may be used for communicating between the processor 404 and the system memory 406. The basic configuration 402 is illustrated in FIG. 4 by those components within inner dashed line.

Depending on the desired configuration, the processor 404 may be of any type, including but not limited to a microprocessor (μP), a microcontroller (μC), a digital signal processor (DSP), or any combination thereof. The processor 404 may include one more levels of caching, such as a level cache memory 412, a processor core 414, and registers 416. The example processor core 414 may include an arithmetic logic unit (ALU), a floating point unit (FPU), a digital signal processing core (DSP Core), or any combination thereof. An example memory controller 418 may also be used with the processor 404, or in some implementations the memory controller 418 may be an internal part of the processor 404.

Depending on the desired configuration, the system memory 406 may be of any type including but not limited to volatile memory (such as RAM), non-volatile memory (such as ROM, flash memory, etc.) or any combination thereof. The system memory 406 may include an operating system 420, a content distribution application 422, and program data 424. The content distribution application 422 may include an analytics module 426 to provide distribution of the user interface content with differentiated analytics payload elements injected to each control point. The program data 424 may include, among other data, analytics data 428 associated with one or more control points, or the like, as described herein.

The computing device 400 may have additional features or functionality, and additional interfaces to facilitate communications between the basic configuration 402 and any desired devices and interfaces. For example, a bus/interface controller 430 may be used to facilitate communications between the basic configuration 402 and one or more data storage devices 432 via a storage interface bus 434. The data storage devices 432 may be one or more removable storage devices 436, one or more non-removable storage devices 438, or a combination thereof Examples of the removable storage and the non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 406, the removable storage devices 436 and the non-removable storage devices 438 are examples of computer storage media. Computer storage media includes, but is not limited to, RAM, ROM, EEPROM, flash memory or other memory technology, CD ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 400. Any such computer storage media may be part of the computing device 400.

The computing device 400 may also include an interface bus 440 for facilitating communication from various interface devices (for example, one or more output devices 112, one or more peripheral interfaces 444, and one or more communication devices 466) to the basic configuration 402 via the bus/interface controller 430. Some of the example output devices 442 include a graphics processing unit 448 and an audio processing unit 450, which may be configured to communicate to various external devices such as a display or speakers via one or more A/V ports 452. One or more example peripheral interfaces 444 may include a serial interface controller 454 or a parallel interface controller 456, which may be configured to communicate with external devices such as input devices (for example, keyboard, mouse, pen, voice input device, touch input device, etc.) or other peripheral devices (for example, printer, scanner, etc.) via one or more I/O ports 458. An example communication device 466 includes a network controller 460, which may be arranged to facilitate communications with one or more other computing devices 462 over a network communication link via one or more communication ports 464. The one or more other computing devices 462 may include servers, customer equipment, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 400 may be implemented as a part of a general purpose or specialized server, mainframe, or similar computer that includes any of the above functions. The computing device 400 may also be implemented as a personal computer including both laptop computer and non-laptop computer configurations.

Example embodiments may also include methods for providing injected analytics service for web distributed interfaces. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be with a machine that performs a portion of the program. In other examples, the human interaction can be automated such as by pre-selected criteria that may be machine automated.

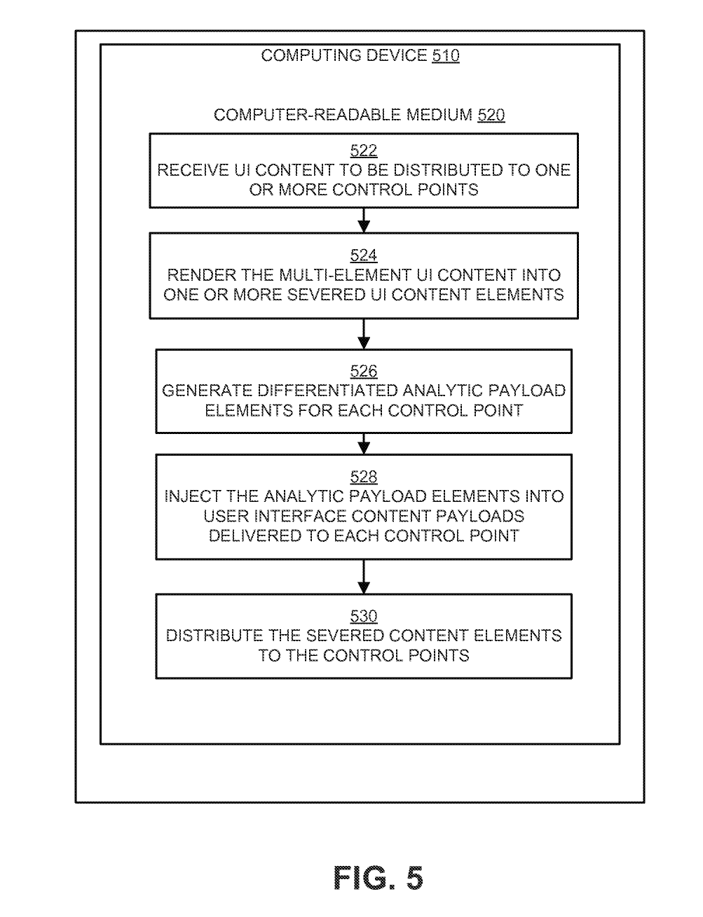

FIG. 5 is a flow diagram illustrating an example method that may be performed by a computing device such as the computing device in FIG. 4, arranged in accordance with at least some embodiments as described herein.

Example methods may include one or more operations, functions or actions as illustrated by one or more of blocks 522, 524, 526, 528 and 530, and may in some embodiments be performed by a computing device such as the computing device 400 in FIG. 4. The operations described in the blocks 522-530 may also be stored as computer-executable instructions in a computer-readable medium such as a computer-readable medium 520 of a computing device 510.

An example process for providing an injected analytics service for web-distributed interfaces may begin with block 522, “RECEIVE UI CONTENT TO BE DISTRIBUTED TO ONE OR MORE CONTROL POINTS”, where the first server 222 of the user interface (UI) content distribution system 220 may receive UI content to be distributed to one or more control points from a content provider. The one or more control points may include a user, a session, and/or a device.

Block 522 may be followed by block 524, “RENDER THE MULTI-ELEMENT UI CONTENT INTO ONE OR MORE SEVERED UI CONTENT ELEMENTS”, where the first server 222 may render the UI multi-element content 210 into one or more severed UI content elements 223 and provide the one or more severed UI content elements 223 to the second server 224.

Block 524 may be followed by block 526, “GENERATE DIFFERENTIATED ANALYTICS PAYLOAD ELEMENTS FOR EACH CONTROL POINT”, where the analytics engine 228 may generate the analytics payload elements 229 for each UI content element 223 to be distributed. The analytics payload element may be differentiated for each content element 223 based on each control point the UI content element 223 is being distributed to. The analytics payload element may be differentiated by inserting a different token into each element such that analytics profiles for control points associated with the analytics elements are maintained separate.

Block 526 may be followed by block 528, “INJECT THE ANALYTICS PAYLOAD ELEMENTS INTO USER INTERFACE CONTENT PAYLOADS DELIVERED TO EACH CONTROL POINT”, where the generated analytics payload elements 229 may be injected into corresponding content payloads by the second server 224.

Block 528 may be followed by block 530, “DISTRIBUTE THE SEVERED CONTENT ELEMENTS TO THE CONTROL POINTS”, where the analytics injected UI content elements may be distributed to the one or more control points through the element distributor 225. One or more UI content elements may be distributed to one or more interfaces at the control point.

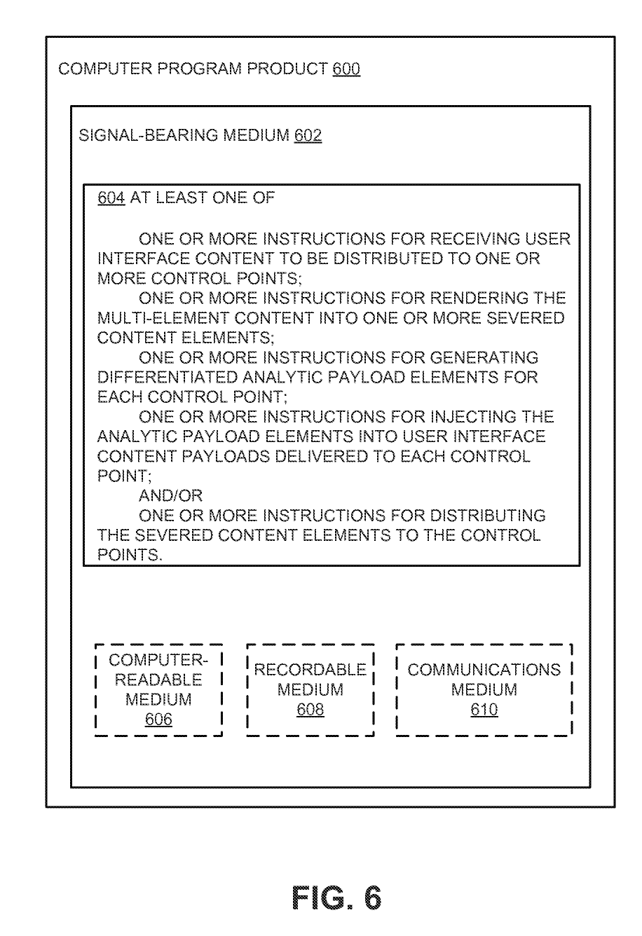

FIG. 6 illustrates a block diagram of an example computer program product, arranged in accordance with at least some embodiments as described herein.

In some examples, as shown in FIG. 6, the computer program product 600 may include a signal bearing medium 602 that may also include one or more machine readable instructions 604 that, when executed by, for example, a processor, may provide the functionality described herein. Thus, for example, referring to the processor 404 in FIG. 4, the content distribution application 422 and the analytics module 426 may undertake one or more of the tasks shown in FIG, 6 in response to the instructions 604 conveyed to the processor 404 by the medium 602 to perform actions associated with providing injected analytics service for web distributed interfaces as described herein. Some of those instructions may include, for example, receiving user interface content to be distributed to one or more control points, rendering the multi-element content into one or more severed content elements, generating differentiated analytics payload elements for each control point, injecting the analytics payload elements into user interface content payloads delivered to each control point, and/or distributing the severed content elements to the control points, according to some embodiments described herein.

In some implementations, the signal bearing medium 602 depicted in FIG. 6 may encompass a computer-readable medium 606, such as, but not limited to, a hard disk drive, a solid state drive, a Compact Disc (CD), a Digital Versatile Disk (DVD), a digital tape, memory, etc. In some implementations, the signal bearing medium 602 may encompass a recordable medium 608, such as, but not limited to, memory, read/write (R/W) CDs, R/W DVDs, etc. In some implementations, the signal bearing medium 602 may encompass a communications medium 610, such as, but not limited to, a digital and/or an analog communication medium (for example, a fiber optic cable, a waveguide, a wired communications link, a wireless communication link, etc.). Thus, for example, the program product 600 may be conveyed to one or more modules of the processor 604 by an RF signal bearing medium, where the signal bearing medium 602 is conveyed by the wireless communications medium 610 (for example, a wireless communications medium conforming with the IEEE 802.11 standard).

According to some examples, a method is provided for providing an analytics service for web distributed interface. The method may include receiving user interface content to be distributed to one or more control points and generating differentiated analytics payload elements for each control point at a point of user interface content distribution. The method may also include injecting the analytics payload elements into user interface content payloads delivered to each control point.

According to other examples, each control point may include one of a user, a session, and/or a device. A different token may be inserted into each analytics payload element such that analytics profiles for control points associated with the analytics payload elements are maintained separate. The analytics profiles may be individualized through the tokens so that when multiple devices or users are part of a same application session or log in, the devices or users may generate distinct analytics output for data processing and analysis. The user interface content may be received through multi-element content delivered to a user interface distribution system. The multi-element content may be rendered into one or more severed content elements and the severed content elements may be distributed to the control points by an element distributor module. The severed content elements may include duplicate elements among the users.

According to further examples, each analytics payload element may be enabled to connect back to the analytics service. The analytics data may be delivered from the analytics payload elements to a distributed user interface analytics database. Existing analytics payload elements may be replaced with individualized analytics payload elements that use the same analytics service and account number so that direct feedback is provided to an original application associated with the existing analytics payload elements. Replacing the existing analytics payload elements with individualized analytics payload elements may include adding a dynamic uniform resource locator (URL) string to indicate a user identity and control elements among the distributed user interface content. Which user interface content elements are sent to which users and in what fashion may be recorded based on establishing a connection between a user interface element distributor and a DUI database. In response to a determination that a user has to log in in order to use the distributed user interface content, user identity information may be taken into account when generating the analytics payload elements. Analytics payload elements may be gated based on restriction of user interface content distribution to one or more of a user, a device, and a session.

According to some embodiments, a user interface content distribution system operable to provide an analytics service for web distributed interfaces is described. The system may include a first server configured to receive user interface content to be distributed to one or more control points. The system may also include an analytics engine configured to generate differentiated analytics payload elements for each control destination and inject the analytics payload elements into user interface content payloads delivered to each control point. The system may further include a. second server configured to distribute the user interface content with the analytics payload elements to the control points.

According to other embodiments, each control point may include one of a user, a session, and/or a device. The analytics engine may be further configured to insert a different token into each analytics payload element such that analytics profiles for control points associated with the analytics payload elements are maintained separate. The analytics engine may be further configured to individualize the analytics profiles through the tokens so that when multiple devices or users are part of a same application session or log in, the devices or users generate distinct analytics output for data processing and analysis. The first server may be configured to receive the user interface content by receiving multi-element content delivered to the user interface content distribution system. The first server may be configured to render the multi-element content into one or more severed content elements and the second server may be configured to distribute the severed content elements to the control points through an element distributor module. The severed content elements may include duplicate elements among the users.

According to further embodiments, the first server may be configured to receive the user interface content by retrieving multi-element content from a content provider. Each analytics payload element may be enabled to connect back to the analytics service. The analytics service may be configured to deliver analytics data from the analytics payload elements to a distributed user interface analytics database, where the analytics service may be executed on a third server separate from the user interface content distribution system and the distributed user interface analytics database is managed by one of the first and second servers. The analytics engine may be executed on one of the first and second servers and a fourth server may be configured to provide the user interface content to be distributed.

According to yet further embodiments, the analytics engine may be further configured to replace existing analytics payload elements with individualized analytics payload elements that use the same analytics service and account number so that direct feedback may be provided to an original application associated with the existing analytics payload elements. The analytics engine may be configured to replace the existing analytics payload elements with individualized analytics payload elements by adding a dynamic uniform resource locator (URL) string to indicate a user identity and control elements among the distributed user interface content. The analytics engine may be further configured to take user identity information into account when generating the analytics payload elements in response to a determination that a user has to log in in order to use the distributed user interface content. The analytics engine may be further configured to limit the analytics payload elements based on restriction of user interface content distribution to one or more of a user, a device, and a session. The user interface content distribution system may be part of one of an Internet Service Provider (ISP), a routing device provider, a Software as a Service (SaaS) entity, and an independent analytics service. The user interface content with the analytics payload elements may be distributed by a middleware layer at a content provider, and users may be enabled to configure the distribution.

According to some examples, a user interface content distribution system operable to integrate an analytics service for web distributed interfaces is described. The system may include a content module configured to receive user interface content to be distributed to one or more control points. The system may also include an analytics engine configured to generate differentiated analytics payload elements for each control destination and inject the analytics payload elements into user interface content payloads delivered to each control point. The system may further include an clement distributor configured to distribute the user interface content with the analytics payload elements to the control points.

According to other examples, each control point may include one of a user, a session, and/or a device. The user interface content distribution system may be part of a user-side application, the content module and the element distributor may be implemented in a distributed user interface layer over a content layer, and the analytics engine may be implemented in a web server gateway interface (WSGI) layer over the distributed user interface layer. The analytics engine may be further configured to insert a different token into each analytics payload element such that analytics profiles for control points associated with the analytics payload elements may be maintained separate. The content module may be configured to receive the user interface content by receiving multi-element content delivered to the user interface content distribution system.

According to further examples, each analytics payload element may be enabled to connect back to the analytics service. The analytics service may be configured to deliver analytics data from the analytics payload elements to a distributed user interface analytics database managed by the user interface content distribution system. The analytics engine may be further configured to take user identity information into account when generating the analytics payload elements in response to a determination that a user has to log in in order to use the distributed user interface content. The analytics engine may be further configured to limit the analytics payload elements based on a restriction of user interface content distribution to one or more of a user, a device, and a session.

According to some embodiments, a computer readable storage medium may be described. The computer readable storage medium may include instructions stored thereon, which when executed may cause a method for providing an analytics service for web distributed interfaces to be executed by one or more computing devices, where the method includes actions of claims 1-14.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (for example, hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (for example, as one or more programs running on one or more computer systems), as one or more programs running on one or more processors (for example, as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to Which such claims are entitled. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, a solid state drive, etc.; and a transmission type medium such as a digital and/or an analog communication medium (for example, a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (for example, feedback for sensing position and/or velocity of gantry systems; control motors for moving and/or adjusting components and/or quantities).

A system may be implemented using any suitable commercially available components, such as those typically found in user interface (UI) content distribution systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations.

Furthermore, in those instances where a convention analogous to “at least one of A, B, and C, etc,” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method to provide an analytics service for web distributed interfaces, the method comprising:
receiving user interface content to be distributed to one or more control points, wherein each control point includes one of a user, a session, and/or a device;
generating differentiated analytics payload elements for each control point at a point of user interface content distribution; and
injecting the analytics payload elements into user interface content payloads delivered to each control point.

2. (canceled)

3. The method according to claim 1, further comprising:
inserting a different token into each analytics payload element such that analytics profiles for control points associated with the analytics payload elements are maintained separate; and
individualizing the analytics profiles through the tokens so that when multiple devices or users are part of an application session, distinct analytics output is generated for data processing and analysis based on the devices or users.

4. (canceled)

5. The method according to claim 1, wherein receiving the user interface content comprises:
receiving multi-element content delivered to a user interface distribution system,
rendering the multi-element content into one or more severed content elements that include duplicate elements among the users; and
distributing the severed content elements to the control points by an element distributor module.

6. (canceled)

7. (canceled)

8. The method according to claim 1, further comprising:
enabling each analytics payload element to connect back to the analytics service.

9. The method according to claim 1, further comprising:
delivering analytics data from the analytics payload elements to a distributed user interface analytics database.

10. The method according to claim 1, further comprising:
replacing existing analytics payload elements with individualized analytics payload elements that use the analytics service and account number so that direct feedback is provided to an original application associated with the existing analytics payload elements.

11. The method according to claim 10, wherein replacing the existing analytics payload elements with individualized analytics payload elements comprises adding a dynamic uniform resource locator (URL) string to indicate a user identity and control elements among the distributed user interface content.

12. The method according to claim 1, further comprising:
recording which user interface content elements are sent to which users and in what fashion based establishing a connection between a user interface element distributor and a DUI database.

13. The method according to claim 1, further comprising:
in response to a determination that a user has to log in in order to use the distributed user interface content, taking user identity information into account when generating the analytics payload elements.

14. The method according to claim 1, further comprising:
gating the analytics payload elements based on restriction of user interface content distribution to one or more of a user, a device, and a session.

15. A user interface content distribution system operable to provide an analytics service for web distributed interfaces, the system comprising:
a first server configured to:
receive user interface content to be distributed to one or more control points, wherein each control point includes one of a user, a session, and/or a device;
an analytics engine configured to:
generate differentiated analytics payload elements for each control destination; and
inject the analytics payload elements into user interface content payloads delivered to each control point; and
a second server configured to:
distribute the user interface content with the analytics payload elements to the control points.

16. (canceled)

17. The system according to claim 15, wherein the analytics engine is further configured to:
insert a different token into each analytics payload element such that analytics profiles for control points associated with the analytics payload elements are maintained separate; and
individualize the analytics profiles through the tokens so that when multiple devices or users are part of an application session, distinct analytics output is generated for data processing and analysis based on the devices or users.

18. (canceled)

19. The system according to claim 15, wherein
the first server is configured to receive the user interface content by receiving multi-element content delivered to the user interface content distribution system;
the first server is configured to render the multi-element content into one or more severed content elements that include duplicate elements among the users; and
the second server is configured to distribute the severed content elements to the control points through an element distributor module.

20. (canceled)

21. (canceled)

22. (canceled)

23. The system according to claim 15, wherein each analytics payload element is enabled to connect back to the analytics service.

24. The system according to claim 15, wherein the analytics service is configured to deliver analytics data from the analytics payload elements to a distributed user interface analytics database and, wherein the analytics service is executed on a third server separate from the user interface content distribution system and the distributed user interface analytics database is managed by one of the first and second servers.

25. (canceled)

26. The system according to claim 15, wherein the analytics engine is executed on one of the first and second servers.

27. The system according to claim 15, further comprising a fourth server configured to provide the user interface content to be distributed.

28. (canceled)

29. (canceled)

30. (canceled)

31. The system according to claim 15, wherein the analytics engine is further configured to:
limit the analytics payload elements based on restriction of user interface content distribution to one or more of a user, a device, and a session.

32. The system according to claim 15, wherein the user interface content distribution system is part of one of an Internet Service Provider (ISP), a routing device provider, a Software as a Service (SaaS) entity, and an independent analytics service.

33. The system according to claim 15, wherein the user interface content with the analytics payload elements is distributed by a middleware layer at a content provider, and users are enabled to configure the distribution.

34. A user interface content distribution system operable to integrate an analytics service for web distributed interfaces, the system comprising:
a content module configured to:
receive user interface content to be distributed to one or more control points;
an analytics engine configured to:
generate differentiated analytics payload elements for each control destination; and
inject the analytics payload elements into user interface content payloads delivered to each control point; and
an element distributor configured to:
distribute the user interface content with the analytics payload elements to the control points.

35. (canceled)

36. The system according to claim 34, wherein the user interface content distribution system is part of a user-side application, the content module and the element distributor are implemented in a distributed user interface layer over a content layer, and the analytics engine is implemented in a web server gateway interface (WSGI) layer over the distributed user interface layer.

37. (canceled)

38. (canceled)

39. (canceled)

40. (canceled)

41. The system according to claim 34, wherein the analytics engine is further configured to:
in response to a determination that a user has to log in in order to use the distributed user interface content, take user identity information into account when generating the analytics payload elements; and
limit the analytics payload elements based on a restriction of user interface content distribution to one or more of a user, a device, and a session.

42. (canceled)

43. (canceled)
